(19) United States
(12) Patent Application Publication
(10) Pub. No.: US 2002/0069208 A1
(43) Pub. Date: Jun. 6, 2002

(54) Method of and system for generating data-base compilation and storage, accessing, comparing and analyzing of scanned genetic spot pattern images and the like

(75) Inventor: R. David Rines, San Antonio, TX (US)

Correspondence Address: Rines and Rines, 81 North State Street, Concord, NH, 03301, US

(73) Assignee: Academy of Applied Science

(21) Appl. No.: 09/731,519

(22) Filed: Dec. 6, 2000

(51) Int. Cl. G06F 7/00

(52) U.S. Cl. 707/104.1

(57) ABSTRACT

A new method of and system for generating, storing and accessing genomic information provided in the format of spot pattern images of electrophoretically separated gene fragments and the like to derive from appropriately customized assay kits, using standardized formats of such spot pattern images for storage in an image database library, and with preferably internet two-way communication between remote research or diagnostic customers or users and the central data base library for permitting customers remote inputting of spot pattern images for growing the data base and/or for analysis, customer retrieval of stored data base library images, and for communicating image comparison and analysis services from the database library to the customers or users—such constituting also a new method of doing business in this field.

### FIELD OF INVENTION

The present invention relates to the generating, data-base storage, accessing and comparison of scanned genetic spot pattern images and the like that represent genetic characteristics and information; being more particularly directed to two-dimensional spot patterns produced by two-dimensional gene scanning (TDGS), as by electrophoresis, as analyzed by a gel documentation system using fluorescence or other luminescence to produce spot patterns that are specific to the genes under test, and the genetic make-up of the individual whose genes are tested.

As described, for example, in U.S. Pat. No. 6,007,231, Method of Computer Aided Automatic Diagnostic DNA Test Designs and Apparatus Therefor, U.S. Pat. Nos. 5,865,975 and 6,036,831, Automatic Protein and/or DNA Analysis System and Method, (all assigned to the Academy of Applied Science, the founder of Accelerated Genomics, Inc. the assignee of the present invention), and in my paper entitled, “Comprehensive mutational scanning of the p53 coding region by two-dimensional gene scanning” (Rines et. al., Carcinogenesis, vol. 19, no. 6, 1979), these two-dimensional (2-D) gene scanning (TDGS) techniques are based on denaturing gradient gel electrophoresis in a two-dimensional format. This enabling, by gene spot patterns in the gel, analysis of an entire gene for all possible mutations in one gel under one set of conditions. The combination of extensive multiplex PCR and 2-D separation makes TDGS one of the very few techniques capable of analyzing many target fragments in parallel. It is, moreover, the only technique capable of parallel analysis while retaining the ability of discovering unknown variants. By enabling screening of multiple genes in parallel, moreover, this technique shows promise in effectively addressing multi-gene involvement in both research and diagnostic testing settings.

### BACKGROUND

Considering the gene spot patterns in the gels, produced with the above TDGS technique, the 2-D electrophoresis component provides spot patterns of gene fragment separation in a non-denaturing gel according to size, as well as base pair sequences in a denaturing gradient gel, as fully explained in the above references. Each fragment can therefore be uniquely identified in the spot pattern by x-y coordinates. The inclusion of heteroduplexing after the PCR operation, furthermore, facilitates detection of heterozygous mutations or polymorphisms as four spots, rather than one, on the gel spot pattern: two homoduplex and two heteroduplex variations as detailed in said patents and paper.

There are, however, other methods of detection of gene variants, including mutational screening methods that are capable of detecting previously identified mutations or polymorphisms. Such methods score the presence or absence of such a known gene variant. Examples of technology platforms based on such methods are the Mass ARRAY system of Sequenom, the Orchid SNP stream platform, and highly publicized DNA chips. None of these methods, however, has the capacity of discovering novel variants and none is capable of exhaustively scanning genes for additional variants—having thus inherent limitations that make such techniques less than suitable for the necessary large-scale human genetic variation studies and data-bank storage now so desirable, be it in pharmacogenomics, disease-gene hunting or in any other area.

Another type of mutation detection systems are the so-called mutational scanning methods, such as nucleoide sequencing, which “scans” each gene for all possible mutations or polymophisms—a costly practice in large and multiple genes or when large sample numbers are involved. More cost-effective alternatives reside in the above-described two-dimensional gene scanning (TDGS), and in DBPLC, which, however, operates as a fragment by fragment basis (and, unlike TDGS, cannot analyze and make spot patterns of multiple fragments in parallel—nor can entire assays be carried out under one and the same conditions).

With the TDGS technique, however, image analysis of the gene fragment gel spot patterns, as described more particularly in said patents, and the developing internet—based technologies, the possibility is now presented to generate a novel centralized TDGS-based population variant database of stored spot pattern images (and digital information thereon). The present invention, in standardizing the spot pattern image formats attained by academics and industrial organizations that are focused on large population genetic studies and gene discovery research, using appropriate TDGS assay kits for different genes of their own interest, now enables the generation of a centralized database or library of such images and the establishment of a network for centrally storing, exchanging, analyzing and comparing gene spot pattern image data so generated; this, for the first time, enabling the transforming of raw genetic data into routinely applicable marker systems for clinically and/or economically important traits (e.g. drug response and disease susceptibility in humans and/or animals; growth characteristics and disease resistance in animals and plants, etc.).

In accordance with this novel approach of the present invention, expanded collection of data on a global scale is practicable and should provide considerable utility in agricultural and marine management, research aimed at clarifying the genetics associated with the onset and progression of many diseases, validating gene-based drug targets and identifying target populations for new drugs and gene-based diagnostic services, including those predictive of drug response (pharmacogenomics). Such use of the TDGS test kits, either in terms of research services or independent research, presents opportunities to begin improving the research and ultimately diagnostic utility of the platform. Because the TDGS spot patterns, produced through the use of uniform reaction conditions or a “kit” (including for example specific PCR primers, reaction conditions and gel conditions) are gene specific and individual specific, they readily lend themselves to image analysis based interpretation of results. Because the spot patterns are also product specific, they offer the possibility to assemble commercial intellectual property rights governing their use in this capacity.

In exchange for the submission of gene/individual specific TDGS spot patterns and associated phenotypic (trait/characteristics) data to the database, researchers can now gain access to research results obtained by TDGS based research worldwide. This approach will facilitate the generation of statistically significant findings on a global scale. Further, mating the database to existing genomic and proteomic tools (for example protein modeling software/resources and existing and emerging genetic variant databases) provides the opportunity for researchers to rapidly establish functional significance of their findings. The establishment of the spot pattern database system will provide researchers with the opportunity to conduct studies of unprecedented scope that can be immediately compared to data gathered from studies occurring worldwide, dramatically enhancing the appeal of the technology platform. Further, effective mining of the database will allow the validation of diagnostic services and the identification of suitable target populations. The development of such a database library of core spot pattern images, moreover, provides opportunities to mine the collected data and assemble marker systems of high diagnostic and commercial utility for a variety of industries that are coupled to the use of TDGS assays. Because the database (currently referred to as the Origin Diversity™ Database) will be compiled from multi-gene research from populations all over the world, this spot pattern database may be the first of its kind, allowing the Scientific/Medical community directly to address issues of multi-gene involvement in the predisposition, onset and treatment of many diseases at both the research and diagnostic testing levels

### OBJECTS OF INVENTION

A principal object of the present invention, accordingly, is to provide such a new and improved method of and system for generating and compiling and storing in a centralized database, scanned genetic spot pattern images and the like, adapted for accessing, comparing and analyzing of the images, and for the contributing to the database of such pattern image data from researchers on a wide scale, hopefully global, and for exchanging information therewith.

A further object is to provide such a novel system and technique that is particularly adapted for TDGS patterns, such as are produced by two-dimensional gene scanning by electrophoresis, as analyzed by gel documentation systems specific to the genes under test and to the individual(s) whose genes are tested.

Still a further object is to provide such a new system in which TDGS assay kits are provided to the researchers, and standardized spot pattern image formats are established for installing the database compilation, storage and analysis.

An additional object is to provide a new and improved method of doing or conducting the business of genetic information data-based compilation, accessing and analyzing, on a wide scale, using spot pattern images and the like as the database core.

Other and further objects will be explained hereinafter and are more particularly delineated in the appended claims.

### SUMMARY

In summary, however, from one of its important viewpoints, the invention embraces a method of generating, storing and accessing genomic information, that comprises, generating image patterns containing such genomic information; storing the image patterns in a database library; linking the database to other bioinformatic tools and resources (for example protein modeling software and databases and other genomic references) and accessing the database for such purposes as including additional of such image patterns for storage in the database to develop the same; retrieving specified image pattern information stored in the database; and image pattern comparison and analysis amongst image patterns.

Preferred and best mode implementations and embodiments shall now be explained in detail in connection with the accompanying drawings.

### DRAWINGS

In the drawings, FIG. 1 is a flow diagram illustrating the steps involved in the preferred implementation of the invention;

FIG. 2 is a summary diagram of multiplex (long distance) PCR (at A), multiplex (short) PCR (at B) and a two-dimensional DNA electrophoresis spot pattern (at C) in accordance with the previous patents; and

FIG. 3 is a business-revenue model diagram.

### DESCRIPTION OF PREFERRED EMBODIMENT(S) OF INVENTION

For illustrative and preferred embodiment purposes, the invention will be described with reference to the before-described multiplex PCR and 2-D gene fragment spot pattern gel electrophoresis separation and image display techniques of the above-referenced patents and paper. Apart from the resulting spot pattern images displayed on the gel, the details of such PCR-electrophoresis operations form no part of the novelty of the present invention (which, indeed, is useful with other pattern images, as well), and are thus only schematically illustrated herein.

Referring to FIG. 1, researchers A, B, C, etc., (and ultimately diagnosticians) are shown at 2 provided with an appropriate TDGS assay kit from 1 for their desired individual respective gene(s), as of the type of enzyme-clamp-assay solutions, etc. described in said patents, and in for example, co-pending U.S. patent application Ser. No. 09/306,333, filed May 6, 1999 for BRCA1 and bMLHI Gene Primer Sequences and Method for testing also assigned to said Academy of Applied Science.

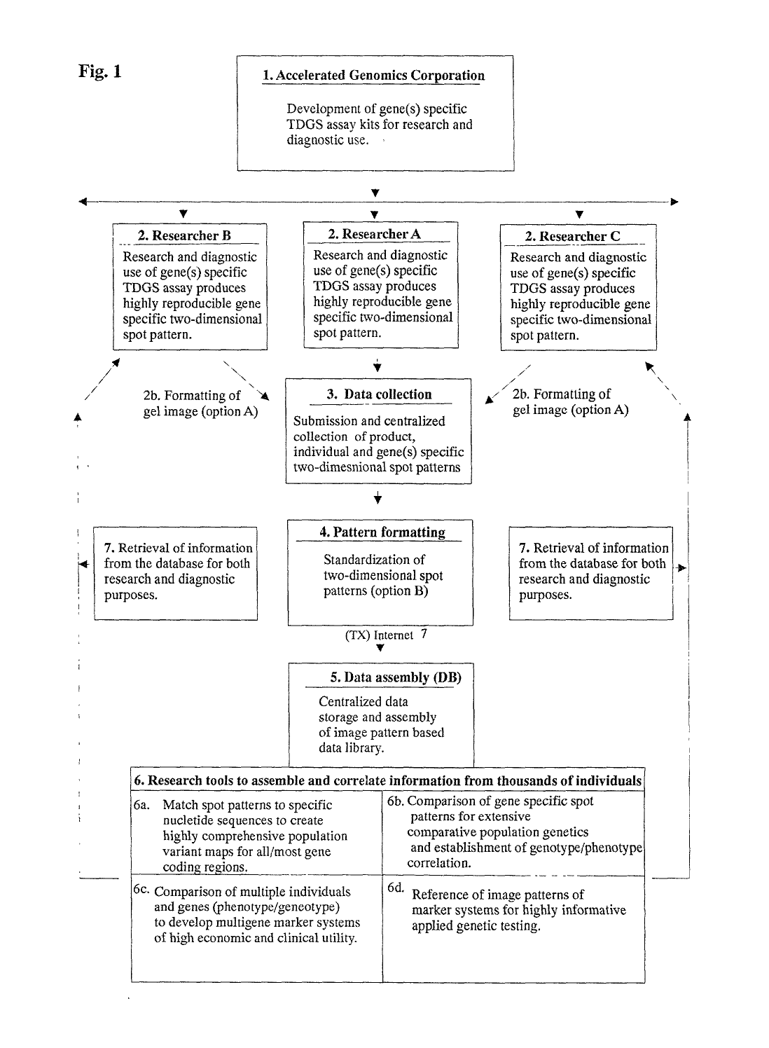

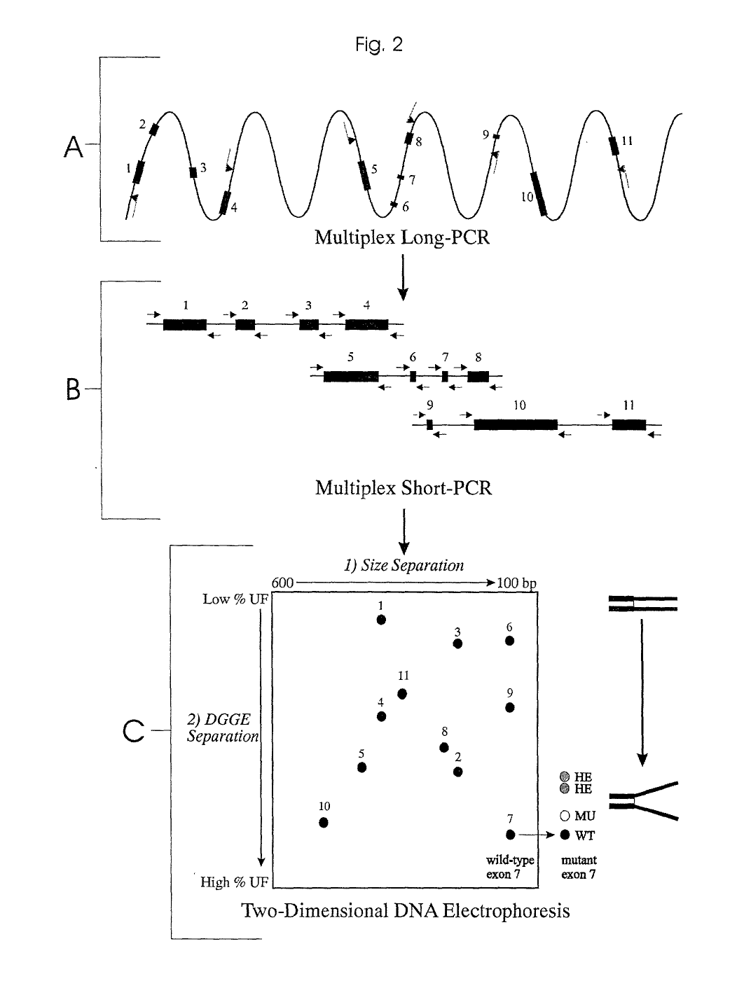

The researchers then perform the multiple PCR-TDGS electrophoresis test(s) (of said patents) at 2, FIG. 1. In brief summary, these involve multiplex long-PCR at (A) in FIG. 2, illustrated for fragments 1-11, multiplex short-PCR at (B), and two-dimensional DNA electrophoresis and display at (C), as detailed in said references. Respective 2-D gene fragment spot pattern images are produced in the gel in FIG. 2C, including, for example, as shown to the right, a previously mentioned mutant exon (7) with its four spots—two homoduplex and two heteroduplex pattern variations (HE, HE, MC, WT). In accordance with the invention these images are then formatted into a standard form (size, contrast, etc.) as by software conventional image-standardizing at 2b (option A), FIG. 1, or formatted at 4 following submission and collection at 3, and then transmitted at TX, preferably over the internet 7, to the central image data-base assembly and library facility DB at 5, which applicant has presently named Origin Diversity™.

At the data-base DB at library 5, the standardized images are stored by appropriate well-known image-storing software (together with converted digital data information thereon and thereof), cataloged by specific gene(s), by the individual whose genes have been tested and by the researcher. As before explained, provided at the central database library DB are research and correlation tools 6 as for making image-comparisons (including, for example, by optical techniques described in said U.S. Pat. Nos. 5,815,975 and 6,036,831) with previously stored spot pattern image data on that gene(s) from others or earlier from the same researcher, with results, again preferably communicated back over the internet as at 7′ to the requesting researcher A, B or C.

A variety of data analysis tools can be incorporated (6, FIG. 1) to advance the research utility of the database DB. For example, spot patterns can be associated with specific nucleotide sequences to establish extensive population variant maps associated with the gene as at (6a). Submitted results can be compared to banked or archived results in the form of spot patterns or other formats to aid the researcher in establishing a genotype-phenotype, as at (6b.). Also possible at 6, FIG. 1, is the linking of the database to existing and emerging protein modeling tools/software and databases and other genomic references to aid the researcher in establishing direct functional impact of a specific variant on a biological or pharmacological (drug mechanism of action) pathway. Comparison of submitted spot patterns with compiled results and associated trait or clinical information can be used to establish relevant diagnostic and economically important marker systems for applied genetic testing (6d, FIG. 1). Further, results can be correlated with established clinically relevant genetic findings, established through the use of TDGS or other methods (6c, FIG. 1) and communicated to a clinician or other user of the database system possibly via the internet as shown in 7′, for highly informative, cost-effective and comprehensive applied genetic testing. The internet, of course, with its low-cost web-site capabilities and security locks is preferred, as before stated; but other two-way communication links between the database library DB and the researchers A, B, C, etc. (or diagnosticians) may also be used, as desired.

In considering the new business opportunities method also underlying this novel image-storing and accessing methodology and system, the provider first receives income from developing and supplying of the special TDGS assay kits (at 1-2) that enable the PCR-electrophoretic development (at 2, FIG. 1) of the specific two-dimensional spot patterns that are produced by the TDGS technology, with their ready applicability for image analysis and data tools. As earlier stated, the spot patterns produced by such two-dimensional gene scanning technology, involving analyzing by a gel documentation system with fluorescence (at 2) or other kinds of luminescence as before explained, are specific to the gene being tested, the specific individual(s) genetic makeup (which is the value of the technology), and are specific to the custom test kit designs. Through the standardized formatting software at 2b or a pattern or image formatting service at 4, highly reproducible and uniform results can be achieved to enhance the archiving and retrieval of the images in the data-base system. Spot patterns submitted from labs all over the world for the same gene, but for a different population (differing by individual) will be stored in this data-base reference tool.

Ultimately, the database will afford a genotyping-phenotyping business service—a genetic makeup and outward appearance of genetic makeup service for researchers. A researcher interested in studying breast cancer, for example, may screen a population in Southern California for breast cancer mutations; and by utilizing the service of the invention, can find out if that mutation or series of mutations has shown up in patients elsewhere in other places of the world.

The invention, furthermore, as earlier noted, also has additional applications once the database has built up for diagnostic testing with two-dimensional gene scanning and other platforms. Physicians or pathologists may want to test for an optimal drug protocol for treatment of a cancer or, more generally, a predisposition of a patient to some disorder. They can similarly use the database system of the invention by testing a patient and referencing the database through the standard formatted two-dimensional image of the two-dimensional gene scanning spot pattern image. A report back at 7′ may inform the physician or the pathologist that this patient might be predisposed to secondary or tertiary occurrences of cancers, indicating appropriate drug dose which may work with this patient or which should be avoided—these conclusions being provided by reference in them to entries made in the database through the stored research and earlier other diagnostic testing.

Not only does the methodology of the invention provide for new research markets for test kits and database building, but a research services market now emerges with customers who “own” a gene and have diagnostic beliefs that warrant population-based screening. The invention offers the alternative of such collecting of population-based data worldwide on the gel, simply by allowing the sale of the customized test kit to customers. Every sale of a test kit to general customers will be prefaced by a research study for the gene, for which a charge to the client may be made. Utilizing the network of companies A, B, C, etc. and with each company screening patients using the TDGS system, can rapidly build the database. There is thus some data utility to the general customer, which further improves the database, and which is why the initial customer, interested in this research service, approaches the DB system in the first place.

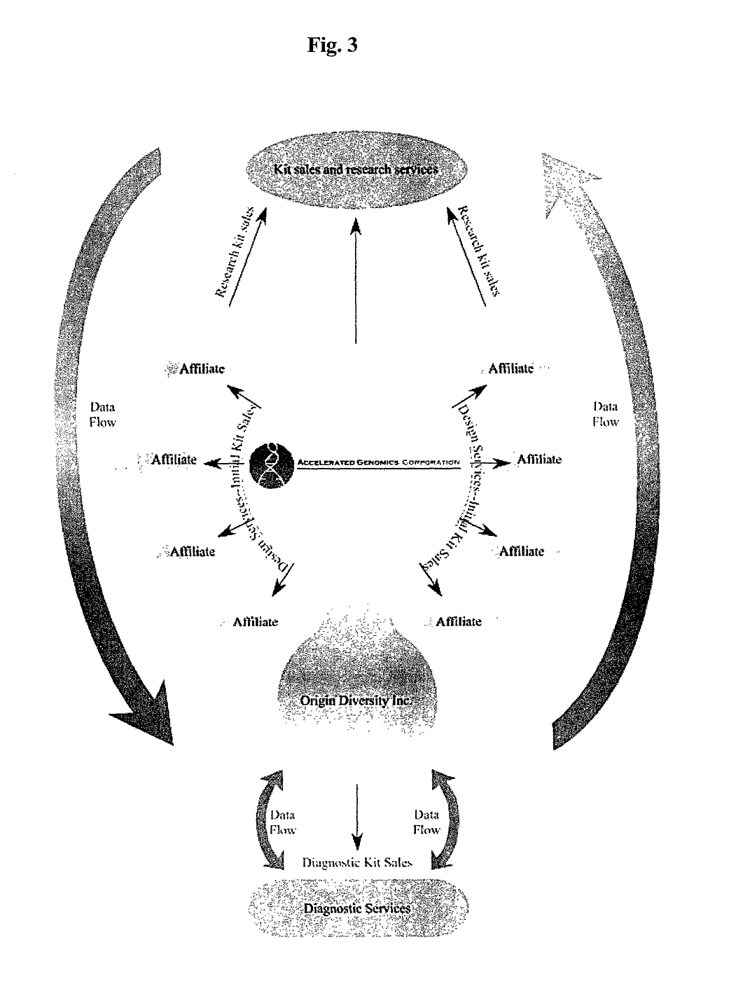

FIG. 3 is an illustrative business model suitable for global application, for doing business with the methodology and overall system and networking of the invention. Data flow and revenue flow from kit design services, and from diagnostic kit sales and research kit sales, so-labeled, supplemental to service charges for operation of the database library DB and its services, predict a new method of doing business in the gene scanning and information storage and accessing market.

The affiliate network thus developed in this contract research services business, with the network's collective access to genetic material from virtually all major population bases, will provide collective assets that have enormous capacity to develop population-based data on a global scale. Therefore, in addition to entering collaborative research arrangements with companies and research institutions for the coordinated or co-offering of industry specific contract research services under this new business method, such will employ also the resources of the affiliates to offer an expanded collection of data on a global scale. This approach promises, as earlier indicated, to provide considerable utility in the validation of gene-based drug targets and the identification of target populations for new drugs and gene-based diagnostic services.

Secondarily, with the research services component of the new invention, an opportunity is provided to develop kits and other product lines that advance the utility of the proprietary findings of others. Similarly, vice versa, it allows the client to improve upon and develop the missing component to the services that the client would ultimately like to offer—be that drug development or diagnostics. In short, anyone with a proprietary gene or commercial interest therein, can benefit from the type of relationship afforded by the business model of the invention; and the underlying image analysis capability and capability to place custom test kits cost-effectively in the hands of researchers, promises rapid generation of global population data.

Further modifications will occur to those skilled in this art, and such are considered to fall within the spirit and scope of the invention as defined in the appended claims.

What is claimed is:

1. A method of generating, storing and accessing genomic information, that comprises, generating image patterns containing such genomic information;
storing the image patterns in a database library; and accessing the database for such purposes as inputting additional of such image patterns for storage in the database to develop the same, the retrieving of specified image pattern information stored in the database, and image pattern comparison and analysis amongst image patterns.

2. A method of generating, storing and accessing genomic information, that comprises, generating image patterns containing such information in the form of spot patterns of gene fragments distributed by electrophoresis in a gel; formatting the image spot patterns for standardized entry into an image database; storing the same in said database; and enabling accessing of the database for such purposes as the inputting of new image spot patterns into the database, the retrieving of specific image spot pattern information stored in the data base, and comparison and analysis amongst image spot patterns.

3. The method of claim 2 wherein the electrophoretic distribution in the gel is effected, following multiplex PCR operation on the gene fragments, by two-dimensional gene scanning electrophoresis.

4. The method of claim 2 wherein one or more of the inputting, retrieving and accessing is effected by external communication with data base customers and users.

5. The method of claim 4 wherein said communication is over the internet.

6. The method of claim 2 wherein the electrophoresis is enabled by providing customized assay kits to the electrophoresis user, designed to facilitate said standardized formatting of the resulting spot pattern images.

7. The method of claim 6 wherein each kit is customized for a specific known gene or genes.

8. The method of claim 6 wherein the kit is designed for an unknown gene or genes.

9. The method of claim 7, wherein the image comparison and analyzing assists in identifying known-mutations of the specified gene(s).

10. The method of claim 7 wherein spot image comparison and analyzing assists in identifying target populations for new drugs candidacy.

11. The method of claim 6 wherein the inputting of new spot pattern images into the database, and the retrieving and accessing of information therefrom is networked to external researchers, diagnosticians and others, enabling the developing of the data base from global population bases, and usage of the data base globally as well.

12. A system for generating, storing and accessing genomic information, having in combination, apparatus for generating image patterns containing such information in the form of spot patterns of gene fragments distributed by electrophoresis on a gel; software designed for formatting the fragment spot patterns for standardized entry into an image database; a database storage and retrieval apparatus for storing the spot pattern images stored in the database; and means for enabling remote accessing of the database for such purposes as the inputting of new image spot patterns into the database, the remote retrieving of specific spot pattern information stored in the database, and the comparison and analysis amongst image spot patterns.

13. The system of claim 12 wherein the electrophoretic distribution in the gel is effected, following multiplex PCR on the gene fragments, by two-dimensional gene scanning electrophoresis apparatus.

14. The system of claim 12 wherein one or more of the inputting, retrieving and accessing is effected by an external two-way communication network provided for and with data base customers and users.

15. The system of claim 14 wherein said communication network is over the internet.

16. A new method of globally doing business in the sale of services and products related to genomic information, that comprises, creating a database library of standardized—formatted electrophoresis gel spot pattern images of specified gene fragments derived from customer contributors to, and users of, the database library; providing customized assay kit products to such customer designed to insure standardization of such formatted spot pattern images for storage in the database library; enabling two-way communication preferably over the internet, between customers and users and the database library for enabling (1) customer or user remote inputting of new electrophoretic spot pattern images of specified genes and individuals, resulting from population studies and/or from diagnostic testing research; (2) providing for communication to such customers and users, comparison and analyzing services of inputted spot pattern images relative to images stored in the data base; and (3) providing spot pattern image information stored in the database, on request, to such customers and users.

17. The method in claim 2 in which the compiled 2-D spot pattern images are directly correlated with protein structure through the linking of the database to protein databases and protein modeling software.

18. The method of claim 1 wherein the database is linked to other bioinformatic resources including other genomic references and protein modeling software and databases.

19. The method of claim 2 wherein the database is linked to other bioinformatic resources including other genomic references and protein modeling software and databases.

20. The method of claim 16 wherein the database is linked to other bioinformatic resources including other genomic references and protein modeling software and databases.
